(19) United States
(12) Patent Application Publication
(10) Pub. No.: US 2008/0271064 A1
(43) Pub. Date: Oct. 30, 2008

(54) PORTABLE INTEGRATED DISC-PUBLISHING DEVICE

(76) Inventors: Dale K. Kubin, Murrieta, CA (US); Nathan P. Scherdin, Poway, CA (US)

Correspondence Address: DOBRUSIN & THENNISCH PC, 29 W LAWRENCE ST, SUITE 210, PONTIAC, MI, 48342, US

(21) Appl. No.: 12/109,005

(22) Filed: Apr. 24, 2008

Related U.S. Application Data
(60) Provisional application No. 60/914,188, filed on Apr. 26, 2007.

(51) Int. Cl. G11B 7/08; G11B 7/24

(52) U.S. Cl. 720/672; 720/718

(57) ABSTRACT

A portable integrated media apparatus comprising: a disc transport movable along at least one axis, and includes a disc engagement mechanism for selective engagement of at least one disc; a print assembly for printing to the at least one disc, the print assembly including: one or more print heads movable about a print axis; at least one recording device for recording to the at least one disc; at least one disc receptacle adapted to store the at least one disc; a control unit for controlling the functions of the disc-publishing device; a data interface for transmitting data; and a data storage component for storing the data; wherein the disc transport and the one or more prints heads are adapted to move independent of each other and wherein the control unit controls one or more functions of the disc-publishing device based on the data received from the data interface, stored in the data storage component, or both.

### CLAIM OF PRIORITY

The present invention claims the benefit of the priority of the filing date of U.S. Provisional Application Ser. No. 60/914,188 filed Apr. 26, 2007, which is herein incorporated by reference for all purposes.

### TECHNICAL FIELD

The field of the present invention relates to disc-publishing devices and more particularly to integrated disc-publishing devices adapted to print to a plurality of disc and optionally record information thereto.

### BACKGROUND OF THE INVENTION

Disc-publishing device manufacturers currently provide consumers with disc-publishing devices configured for processing media (such as storage discs, or otherwise). Such processing requires the use of disc publishing components such as a disc transport for engagement and transfer of storage discs, a print assembly and/or recording device for transferring data to a storage disc, and an external computer for managing the interaction of the operator and the disc-publishing device. Recently, disc-publishing devices manufacturers have attempted to improve the features of disc-publishing device for processing storage discs.

However, the disc-publishing devices have failed to provide a portable unit having stand-alone capabilities. Current disc-publishing devices used in the field to process storage discs using a disc transport need to be connected to an external computer, which can be burdensome specifically when the prior art device is often moved between several locations. These disc-publishing devices fail to cope with the dependency of an external computer, thereby requiring additional space for processing discs, becoming cumbersome when transporting the disc-publishing device to different locations, and more importantly costing the end-user additional money for the purchase of the external computer to operate the current disc-publishing devices.

In view of the forgoing, there is a need for a disc-publishing device, which advantageously can operate independently to reduce and/or eliminate the dependency of a separate external computer to process storage discs.

### SUMMARY OF THE INVENTION

The present invention overcomes the drawbacks of the prior art by providing a portable stand-alone disc-publishing device having an improved compact design, which provides more efficient operation and orientation of the device's components for the handling and use of disc media. As such, this new design further provides an economically priced disc-publishing device, which is advantageously sized for an individual use, small business, or otherwise, and which is more user friendly than prior art disc-publishing devices.

The improved disc-publishing device is designed to compensate for the prior art reliance of an external computer for processing discs by integrating a data interface configured to receive data and a control unit that is capable of controlling the one or more functions of the disc-publishing device based on the received data to process a storage disc using a disc transport and a media component such as a printing assembly, a recording device, the like, or otherwise. An integrated disc-publishing device will allow an end-user to transport and use the disc-publishing device efficiently and cost effectively without additionally requiring and/or relying on an external computer. Advantageously, using the integrated disc-publishing device of the present invention reduces disc processing costs that are associated with purchasing current disc-publishing devices in addition to a separate stand-alone external computer system to operate those prior art devices.

In one aspect, the present invention provides a disc transport movable along at least one axis, a print assembly, at least one recording device, at least one disc receptacle, a data interface, a data storage component, and a control unit, wherein the control unit controls one or more functions of the disc-publishing device based on data received from the data interface, stored on the data storage component, or both.

### BRIEF DESCRIPTION OF THE DRAWINGS

FIG. 1 is a perspective view of a first embodiment of the present invention.

FIG. 2 is another perspective view of the first embodiment of the present invention.

FIG. 3 is another perspective view of the first embodiment of another aspect of the present invention.

FIG. 4 is a perspective view of a second embodiment of the present invention.

FIG. 5 is another perspective view of the second embodiment of the present invention.

FIG. 6 is another perspective view of the second embodiment of the present invention.

### DETAILED DESCRIPTION OF THE INVENTION

The present invention provides improved disc-publishing devices and methods of using thereof, which are comparable or superior in functionality to prior disc-publishing devices while using alternative or additional components. The improved disc-publishing device of the present invention may be used in various applications including printing, copying, recording, viewing, or otherwise data to storage media including, but not limited to: compact discs, digital video discs, the like, combinations thereof or otherwise. More specifically, the improved disc-publishing device of the present invention may be used for practically any application associated with a stand-alone computer such as for creating data. Other stand-alone computer applications are contemplated as well. Advantageously, the improved disc-publishing device is further adapted for engaging and transferring storage discs to one or more media components for processing by way of printing, recording, and/or otherwise to a disc as disclosed in U.S. application Ser. No. 11/335,381 entitled “Printer” and is herein incorporated by reference for all purposes.

Accordingly, in one exemplary configuration, the disc-publishing device meets the above needs by eliminating or reducing the dependency on an external computer, thereby providing a more efficient integrated stand-alone product. In this embodiment, a control unit controls the functions of the disc-publishing device with respect to data received by or stored in the disc-publishing device. This is particularly advantageous in that the disc-publishing device is able to receive and process data without relying on an external computer to do so. Accordingly, not only does the disc-publishing device of the present invention provide a complete stand-alone disc-publishing device, but also helps provide for a portable stand-alone disc-publishing device as well.

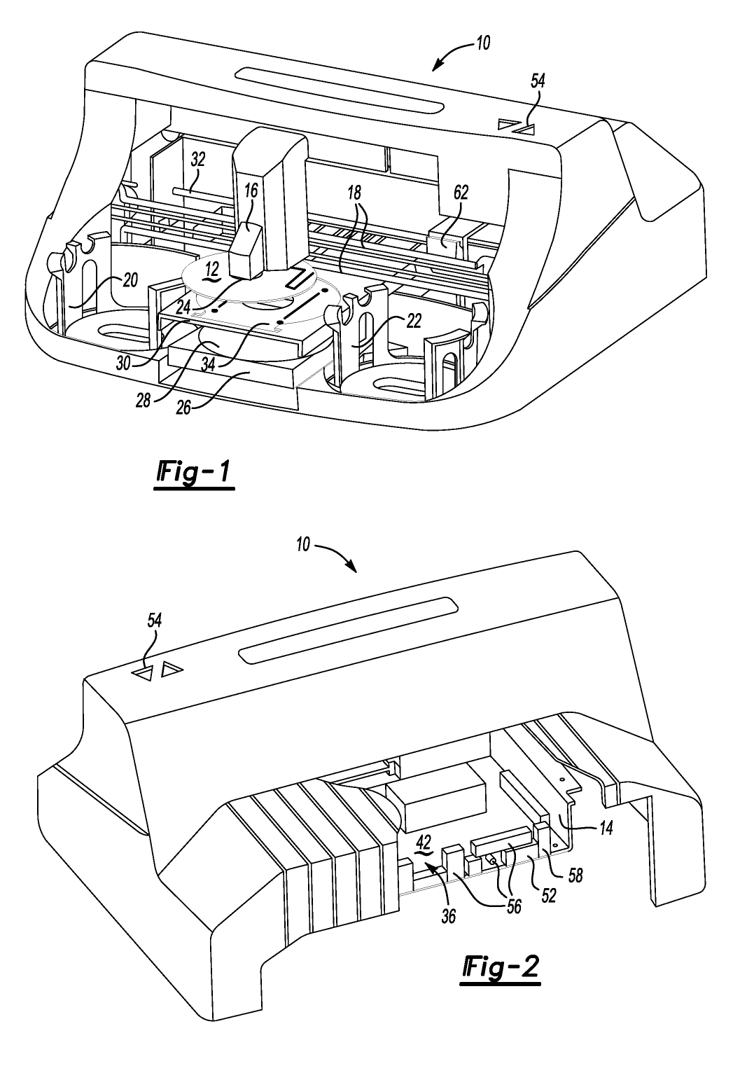

Referring to the drawings, exemplary embodiments and features of the present invention are shown. The present invention provides a disc-publishing device 10, (FIGS. 1-6), for copying, printing, and/or recording of one or more storage devices, such as disc 12. The disc-publishing device includes a housing 14 adapted to provide support and enclosure for one or more of the components of the device. Preferably, the housing is relatively small such that it can be placed upon a desktop or the like. However, the housing may be substantially larger as it is contemplated that the device may comprise numerous components (e.g., recording devices, disc-publishing devices, motherboards, hard drive devices, or otherwise), which may or may not be alike.

The disc-publishing device of the present invention includes a disc transport 16, (FIG. 1), adapted to engage and move with independent movement capabilities one or more discs, preferably one at a time. The disc transport 16 is movably mounted to one or more slide members for movement along more or more axes, which extend along at least a portion of the housing and are mounted or otherwise secured thereto. Preferably, the one or more slide members include a bearing surface for minimizing friction between the disc transport and the one or more slide members. The one or more slide members include the mounting of the disc transport to a first slide member 18, (FIG. 1), which provides slidable movement of the disc transport along a first axis such that a disc may be moved substantially along the same path. It is further appreciated that the one or more slide members may include additional slide members for additional movement of the disc transport along different axes, or otherwise.

The disc transport 16 moves discs from a source location to a target location. The source and/or target location is adapted to receive and/or store a plurality of discs. In a preferred embodiment, the source and/or target location may include one or more disc receptacles. One such location is a disc storage receptacle 20, (FIGS. 1 and 4), which provides storage for the discs that typically have been processed either by way of printing to, recording to, both, or otherwise. Another such location is a disc supply receptacle 22, which provides storage for discs that typically have not been processed, such as with blank discs. The supply and storage receptacles may be fixedly secured to the disc-publishing device housing 14 or may be removable. It is also appreciated that the disc-publishing device may include additional or fewer disc receptacles and/or that the disc receptacles may be movable within the disc-publishing device. For example, one such movable receptacle may be a disc carousel that rotates about a carousel axis and includes one or more receptacles, a receptacle that slides along an axis, a receptacle that is removable, or otherwise.

When installed, the one or more disc receptacles are configured to be in alignment or to become in alignment with an engagement axis, a disc attached to the engagement mechanism of the disc transport or both. The one or more disc receptacles preferably are adapted to hold at least 10 discs, more preferably at least 25 discs, and even more preferably at least 50 discs.

The disc transport is adapted to move along a substantial portion of the first slide member. Accordingly, the disc-publishing device further includes drive means linkably attached to the disc transport, via a linkage or otherwise, to provide a suitable force to move the disc transport to various points along the one or more slide members. Suitable drive member may include a stepper motor or other suitable drive members used for moving a component along a bearing surface or the like. Suitable linkages include belts, cables, chains, screws, the like or otherwise. In a preferred embodiment, the linking mechanism comprises a belt. However, it should be appreciated that numerous types of drive assemblies and linkages are available and may be used, as are commonly utilized in the design of inkjet printers.

The first slide member may comprise of any member adapted to guide an attached member along a portion of its length, width or otherwise. Suitable guiding feature include tracks, shafts, rails, grooves, the like or otherwise. Suitable elongated members includes: shafts, rods, beams, rails, the like or otherwise. However, a most preferred elongated member comprises a rod having a low friction surface such with a bearing surface.

Preferably, the disc transport may be configured with a disc engagement mechanism 24, (1 and 4), adapted to selectively engage a disc portion, for subsequent movement of the disc. The engagement mechanism includes engagement fingers, which when combined form a diameter that generally corresponds to the disc hole formed in the disc 12 and are adapted to move relative to each other. In a first position, the fingers are in a closed position wherein the resulting diameter of the fingers is less than the diameter of the disc hole. Accordingly, the fingers can move into the disc hole without substantial interference. In a second position, the fingers separate and form a diameter that is equal to, or greater than, the diameter of the disc hole such that the fingers engage the inner walls of the disc hole to prevent the disc from disengaging from the disc engager. It should be appreciated that the fingers engage the interior walls of the disc hole and optionally form a friction fit through an application of pressure by the fingers, support the disc from its underside using flanges on one or both fingers, or otherwise and combinations thereof. Optionally, the engagement fingers may include a tapered end portion for assisting in the alignment and insertion of the fingers into the disc hole. Movement of the fingers, with respect to one another, may be achieved using any suitable drive means. Suitable drive means include mechanical, electrical, pneumatic, magnetic or otherwise.

In view of the foregoing, it should be appreciated that upon engagement with the disc, (e.g., movement of the fingers from a first position to a second position), the disc can be moved along the first slide member to different regions of the disc-publishing device 10. Accordingly, when the disc transport reaches a desired location, the engagement fingers move back to the first position, thereby resulting in the disengagement of the disc from the engagement mechanism.

Advantageously, the disc transport may be further configured with one or more additional features, such as a disengagement mechanism, for assisting in the decoupling of the engagement mechanism with a disc by applying a force against the same. Suitable disengagement mechanisms includes resilient members, actuateable members, or otherwise, which may be configured to apply a continuous or selective force against an attached disc. It should be appreciated that other configurations are available.

The disc transport may be further configured with means for movement along a second slide member that is generally perpendicular, though not required, to the first slide member. Preferably, this perpendicular movement is generally vertical with respect to the disc-publishing device; however, other directions are within the scope of the invention. Advantageously, this movement allows the engagement mechanism to be lowered over a disc for engagement or alignment with the same. Subsequently, the disc may be lifted away from the disc source location and moved along the first slide member, to a desired location. Upon arrival to the desired location (e.g., a print location, record location, final destination or otherwise), the disc may be lowered to a select height and released for further processing of the disc or otherwise. Additional axes of movement for the disc transport are appreciated such as movement that is diagonal, rotational, otherwise, or combinations thereof in addition to the axes as discussed herein.

Similar to the movement along the first slide member, the movement along the second slide member of the disc transport may be achieved using any suitable drive means. Suitable drive means include mechanical, electrical, pneumatic, magnetism, the like or otherwise. It should be appreciated that the drive assembly may be activated in an opposite direction (e.g., from the second to the first position) to return the disc transport to its original, previous, or other position. It should be appreciated that the distance between vertical positions of the disc transport may vary due to the changing height of stacked discs, located at the disc storage region or otherwise. Accordingly, the drive means is adapted to align one or more discs at various heights.

Advantageously, the disc transport may further comprise one or more sensors for determining when the engaging mechanism is in a proper location for engaging or releasing a disc. Suitable sensors include pressure sensors, optical sensors, electro mechanical sensors, Hall Effect sensors or otherwise. By example, in one exemplary embodiment, the sensor is located on or associated with the flanges extending from the fingers of the engagement mechanism. The sensors determine when the engagement mechanism is flush with the disc so that upon separation of the fingers, and hence between an upper and lower disc, the engagement mechanism will engage the upper disc.

In view of the forgoing, the present invention is further adapted to perform multiple tasks to create a final disc product. Of these tasks, one particularly useful task includes recording information to the disc for subsequent retrieval. Such information may include music, videos, files, or other types commonly recorded through optical means. Accordingly, in one embodiment, the disc-publishing device further includes a digital recording device 26, (FIG. 1), adapted to record information to a disc. The recording device is configured to receive a disc from the disc transport, subsequently record information to the disc and make the disc available to the disc transport for subsequent tasks or otherwise. Accordingly, it should be appreciated that the information/data to be recorded to the disc may originate from another component, a data interface, as described herein, or otherwise.

The recording device further includes a recording tray 28 that is adapted to reside in a first retracted position, wherein information may be recorded, and extend to a second position for receiving and/or providing a disc to the engaging feature. It should be appreciated that movement of the tray may be achieved using common techniques used in compact disc and digital video disc players and recording devices, or otherwise. It is appreciated that in one embodiment, the disc-publishing device 10 may further include a plurality of recording devices 26, (FIG. 4) for additional recording of information to a plurality of discs. The plurality of recording devices are adapted to work independently of each other and are controlled by the control unit for operation thereof as described herein.

In operation, the recording device extends the recording tray 28, (FIG. 1), to an extended position for receiving a disc from the disc transport 16. If not already located there, the disc transport moves an engaged disc to a position substantially over the recording tray of the recording device. The disc engagement mechanism lowers the disc into the recording tray and releases the disc. The engagement mechanism then moves away from the recording tray and the recording tray is retracted to the first position for recording. Upon completion of recording to the disc, the recording tray extends to an extended position so that the disc transport 16 can retrieve the disc for further processing or otherwise.

Another useful task that may be performed with the present invention includes printing a design, text or otherwise to a disc for identification purposes, or otherwise. Accordingly, the disc-publishing device may further include at least one print assembly 30, (FIGS. 1 and 4), adapted to print to a disc using common printing techniques (e.g., inkjet laser or otherwise). In a preferred embodiment, the print assembly includes one or more print head and ink cartridges having colors commonly associated with inkjet printing (e.g., black, white, reds, blues, greens, combinations thereof as otherwise). The print heads 62 are mounted to a print slide member 32, which preferably extends along at least a portion of the housing and is mounted or otherwise secured thereto. It should be appreciated that the print slide member may include any of the features of the first slide member discussed herein. The mounting of the print assembly to the print slide member provides movement along a print axis, which preferably may be substantially parallel with the first axis, though not required, but does not interfere with the movement of the disc transport located on the first slide member. However, it is contemplated that the location of the print assembly with respect to the movement of the disc transport 16 may vary such that the first axis is substantially perpendicular, or otherwise, to the print axis.

It should be appreciated that the print head further includes a suitable drive means and linkages for movement of the print head along the print slide member. Suitable drive means and linkages may include any of the devices used for movement of the disc transport or any other suitable drive and/or linkage found in the art of printing devices and more particularly the drive configuration of print heads. The print heads are adapted for movement along the print slide member and are adapted for printing directly to a disc located therebelow.

The print assembly further includes a print tray 34, (FIGS. 1 and 4), adapted to receive a disc and provide movement therefore, which preferably is substantially perpendicular to the movement of the printer heads. Advantageously, the print tray is adapted for movement along an axis to effectuate printing. For example, in a preferred embodiment, the print tray is moveable to a first position, which is fully extended and a second position, which is fully retracted. It should be appreciate that during printing, the print tray will move between the first and second position to provide print capability throughout the entire disc located within the print tray.

The print tray is configured with a recess 34 having a center adapted to be substantially concentrically aligned with a disc placed therein. Accordingly, in the extended position, the tray is adapted to receive a disc from the disc transport. For example, it is contemplated that when the disc tray is in a “fully extended” position, the recess portion is concentrically aligned with the center of the disc portion attached to the disc transport located thereabove. In this respect, the print tray is positioned so that the center portion of the print tray is in alignment with the engagement mechanism, wherein the disc transport proceeds to place the engaged disc into the print tray. In one configuration, placement of the disc into the print tray comprises lowering the engagement mechanism to the position just above the print tray, releasing the disc into the tray, and raising the engagement mechanism to a first (e.g., original) position. As previously discussed, the disc transport or engagement mechanism may be calibrated to align the same with the print tray.

Movement of the print tray can be effectuated using any suitable drive mechanism and any linkage thereto, adapted for specific positioning of the print tray, which may include reciprocal movement. Suitable drive mechanisms are known in the art of printing and may include stepper motors or otherwise. In a preferred embodiment, to effectuate specific positioning of the print tray, movement of the print tray is sequenced with the movement and printing of the print head. Preferably, the movement of the print tray and the print head are effectuated through a microcontroller or the control unit of the disc-publishing device, which are adapted to cause the print tray to move to one or more positions, as further discussed herein, so that the one or more print heads can print to a specified region of the disc.

One or more of the components of the disc-publishing device are controllable through a control unit 36, (FIGS. 2, 3, 4, and 6). The control unit of the disc-publishing device may be included as a component of the disc-publishing device or alternatively, the control unit may be included with a separate component, e.g. not incorporated within the disc-publishing device. However, in one specific embodiment, the control unit may be adapted to receive a signal from a data interface, or otherwise, such that function performed by the disc-publishing device is based upon the received signal. Furthermore, the control unit may synchronize the operation of the components of the disc-publishing device (e.g., printing, recording, movement or otherwise) to maximize print efficiency by minimizing cycle time of any task to be performed.

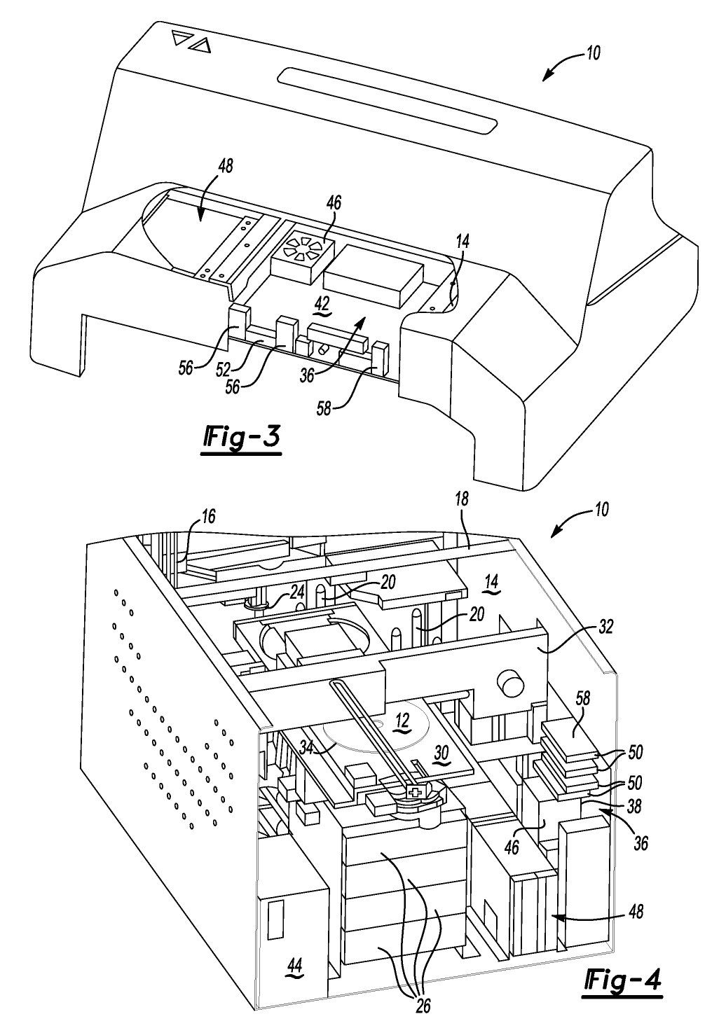

In one embodiment, it should be appreciated that the control unit 36 may include a microprocessor 38, (FIGS. 3 and 6), called the central processing unit (CPU), which generally oversees much of what the control unit does. The control unit further includes system memory 40 that is adapted for very fast storage for holding data and is directly connected to the microprocessor. The microprocessor and the system memory are located on a main circuit board 42, preferably a motherboard, which connects to generally all of the components of the disc-publishing device. The main circuit board may further comprise one or more fans for cooling the components of the disc-publishing device, such as a system fan 44, a microprocessor fan 46, or otherwise, which is positioned generally adjacent to the microprocessor. Other systems may be found directly on the main circuit board or connected to it through a secondary connection. For example, a sound card, a modem, a network adapter, and/or otherwise can be integrated into the main circuit board or connected through a PCI as discussed herein.

There are several types of system memory that may be used in the disc-publishing device, more specifically, in the control unit 36, such as random-access memory (RAM), used to temporarily store information that the control unit is currently working with and read-only memory (ROM), a permanent type of memory storage used by the control unit for important data that does not change. In one embodiment, the control unit further includes a basic input/output system (BIOS), which is a specific type of ROM that may be used by the control unit to establish basic communication to the components of the disc-publishing device when the disc-publishing device is turned on. In another embodiment, the control unit of the disc-publishing device may be adapted for caching, (storing), frequently used data in extremely fast RAM that connects directly to the microprocessor which allows the control unit to access the data in faster application than if the data was stored elsewhere, such as in data storage device, which is discussed below.

In one embodiment, the disc-publishing device 10, (FIG. 4) includes a data storage device 48 such as a hard disk drive, which is a large-capacity permanent storage used to hold information such as programs, documents, pictures, and/or otherwise. The data storage device, preferably, a hard disk drive, includes an operating system (not shown), which may be configured to allow the user to interface with the control unit. The purpose of the operating system is to organize and control the components of the disc-publishing device so that the disc-publishing device behaves in a flexible but predictable way. As such, the operating system manages the hardware and software resources of the disc-publishing device. These system resources include, but are not limited to the processor, memory, printer assembly, etc. In addition to the operating system, the disc-publishing device may include software for performing other disc-publishing device functions, such as component drivers, and/or for communicating with external devices or otherwise. Furthermore, other software may be included to control the disc-publishing device, perform maintenance thereto, or otherwise.

The components of the disc-publishing device 10 communicate with the control unit using component interfaces 50 (FIGS. 2, 3, 4, and 6), such as integrated drive electronics (IDE) controllers, peripheral component interconnect (PCI) bus, SCSI (small computer system interface), AGP (accelerated graphic port), and/or otherwise. The control unit 36 controls the functions of the disc-publishing device and the components therein through the component interfaces, which may be integrated to the main circuit board such as the motherboard. The control unit may further include a sound card and/or a graphics card. The sound card may be used for recording and playing audio by converting analog sound into digital information and back again and the graphic card translates image data from stored within the disc-publishing device or received from a data interface into a format that can be displayed by a graphical interface such as a monitor or otherwise.

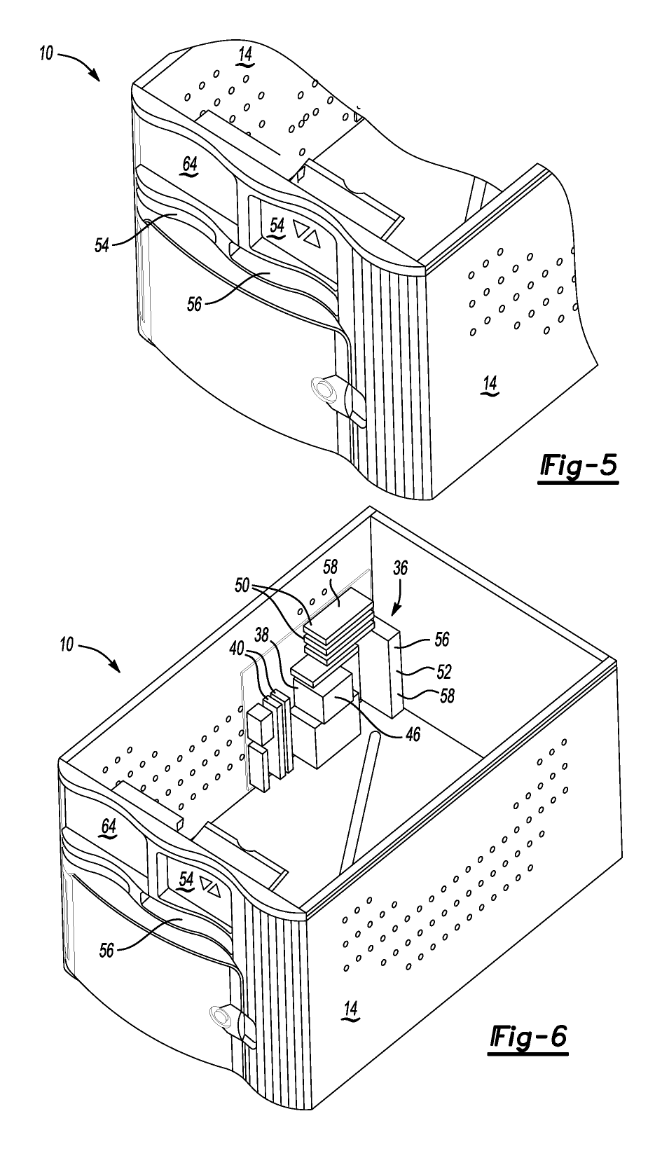

The disc-publishing device 10 may be configured to interface with external components using data interfaces such as input/output (I/O) devices, data ports, and internet/networking ports. A user is able to interact with the disc-publishing device through typical types of I/O device 54 (FIGS. 1 and 5), which include but are not limited to a monitor, a keyboard, a mouse, removable storage, and otherwise. The keyboard and the mouse are primary devices for entering information into the disc-publishing device and navigating and interacting with the disc-publishing device. As discussed above, removable storage devices allow the user to add new information to the disc-publishing device as well as transfer information from the disc-publishing device to the removable storage to carry to a different location. Suitable removable data storage devices include disc drives, ScanDisc, Compact Flash, MicroDrive, Smart Media Card, MultiMedia Card, Memory Stick, Secure Digital Card, Radio Frequency Identification (RFID), or otherwise.

The disc-publishing device 10 may be further configured to interface with external components through data ports 56 such as parallel, serial, universal serial bus (USB), firewire, or otherwise. The disc-publishing device may include at least one port, but preferably more than one.

Additionally, the disc-publishing device may also be configured to interface with external components through the internet/network ports. The disc-publishing device further comprises at least one networking component, which may include a modem, a local area network (LAN) card 58, a wireless adapter 60, (WiFi, 802.11, BLUETOOTH® technology, or otherwise), a cable modem, a digital subscriber line (DSL), very high bit-rate DSL (VDSL) modem, or otherwise.

In one embodiment, the disc-publishing device 10 includes one or more display connectors 52 such as analog connectors, digital video interface (DVI), or otherwise for connecting a removable, (external), display to the disc-publishing device. It is also appreciated that the removable display or other I/O devices may be connected to the disc-publishing device wirelessly through a wireless adapter or using BLUETOOTH® technology.

Optionally or as an alternative to removable display, the integrated disc-publishing device may further include a display panel 64, such as a liquid crystal display (LCD), which may be fixedly secured to the disc-publishing device. The display 64 (FIGS. 5 and 6), and/or the removable display communicate with the control unit through a video adapter, graphic adapter, video card, graphic card or by other known means in the industry, which provides the ability to convert display information into a signal that is sent to the display to be viewed by the user.

Integrating a display panel with the disc-publishing device may be particularly advantageous with regards to operating the disc-publishing device, which may require viewing applications to control the functions of the disc-publishing device. It is appreciated that the disc-publishing device may include one or more displays and that the additional displays may also be removable or fixedly secured to the disc-publishing device.

In yet another embodiment, the display of the disc-publishing device may further adapted for touch-screen functionality. Touch-screen displays are display overlays, which have the ability to display and receive information on the same screen. The effect of such overlays allows a display to be used as an input device. The touch-screen display includes a touch screen sensor for detecting touch input and a micro-controller for taking information from the touch sensor and translates it into information that the control unit can understand. The micro-controller connects the touch-screen display to the control unit 36 for control thereof. The touch-screen display may be used as an I/O device that is configured to enable the user to interface with the disc-publishing device similar to that of a keyboard and a mouse. As such, the touch-screen device may be used in addition to or in place of the one or more I/O devices discussed herein or otherwise.

For example, the touch-screen LCD displays icons (or the like) representing applications, settings, functions, and/or otherwise of the disc-publishing device. A user selects one or more icons, which may include menus and/or sub-menus, of tasks to be preformed by the disc-publishing device. Accordingly, the sensor of the touch-screen LCD detects the selected icon touches contacting the screen of the LCD. The touch-screen LCD microcontroller translates the touches into electronic signals that the control unit of the disc-publishing device can understand. Accordingly, the electrical signal is communicated to the control unit, which then controls the respective components, applications, or otherwise of the disc-publishing device required to accomplish the task to be performed.

In one exemplary method, the operation of the disc-publishing device 10 is demonstrated as follows. A user selects one or more tasks to be performed by the disc-publishing device, via an I/O device. As previously mentioned, such tasks may include recording to a disc, printing to a disc, both, or otherwise, such as creating information data. The I/O device may be a component of the disc-publishing device fixedly secured therein such as the touch-screen display, or otherwise, located proximate to the disc-publishing device (e.g. keyboard, mouse, removable media, or otherwise), or remote to the disc-publishing device (e.g., via a network connection, Internet or otherwise). It should also be appreciated that the I/O device may comprise an integral component of the disc-publishing device (e.g., located externally or otherwise).

Prior to assignment of a task to be performed by the disc-publishing device, the user places one or more discs at the disc supply location. Preferably, the discs are placed in the disc supply receptacle, as discussed herein. Similarly, the disc storage receptacle may be attached or otherwise placed at the disc storage location, also as discussed herein. Optionally, the amount of discs placed in the supply receptacle corresponds to the desired selected storage devices the user wishes to perform tasks to. Accordingly, for printing or recording tasks involving a greater number of discs, which can be placed within the disc receptacles, an optional or additional disc receptacle can be quickly exchanged with substantially no interruption of the print and/or recording operation. It is also appreciated that additional disc receptacles may be incorporated within the disc-publishing device for optimal supply and storage of the discs.

Through an I/O device 54, the user selects one or more tasks to be performed to one or more discs. Often, as discussed below, the task includes both the recording and printing of information. For example, the tasks may include transferring data from a source, which may be an internal hard drive, removable media, media received from the data interface, or otherwise, to one or more discs, in a digital format. In addition, the tasks may also include printing to the recorded discs, which advantageously corresponds to the information transferred to the disc. Accordingly, the task of printing may derive from data stored on a hard drive (e.g. a logo), inputted from an I/O device (e.g. using a keyboard and word processing software or the like), received from an external component, (e.g. through a data interface supplying data from an intranet or internet). Once the tasks have been selected, the operating system, which allows the user to have several programs or tasks in operation at the same time if necessary, ensures that each process and/or application receives enough of the microprocessor's time and system memory to function properly. The path between the operating system and the hardware, (the components of the disc-publishing device such as the disc transport, the print assembly, the recording device, etc), that may not be part of the main circuit board of the control unit goes through a special program called a driver.

Much of a driver's function is to be the translator between the electrical signals of the hardware subsystems and the high-level programming languages of the operating system and application programs. Drivers take data that the operating system has defined as a file and translate them into streams of bits placed in specific locations on storage devices, or a series of laser pulses in a printer.

Managing input and output is largely a matter of managing queues and buffers, special storage facilities that take a stream of bits from a device, perhaps a keyboard, a serial port, or a touch-screen display, hold those bits, and release them to the microprocessor at a rate slow enough for the microprocessor to cope with. This function is especially important when a number of tasks are running and taking up processor time. The operating system will instruct a buffer to continue taking input from the device, but to stop sending data to the microprocessor while the task using the input is suspended. Then, when the task needing input is made active once again, the operating system will command the buffer to send data to the control unit of the disc-publishing device to effectuate synchronized operation of the one or more components of the disc-publishing device corresponding to the tasks requested.

For example, in one method of operation, upon transmission of the task signal to the control unit, the disc transport moves along at least one slide member to the disc supply receptacle, wherein the engagement mechanism is generally in alignment with the disc hole of the disc located in the supply receptacle. The engagement mechanism engages the top disc residing in the supply receptacle. The engagement mechanism then moves (e.g., rises) with a disc to its original position (e.g., above the supply receptacle) so as to prevent interference with the supply receptacle during transferring of the engaged disc.

The disc may be moved along a slide member to the one of the recording devices. Preferably, the recording tray of the recording device is extended so that the engagement mechanism (and the disc attached thereto) may be in alignment with the center of the recording tray of the recording device. The engagement mechanism then moves (e.g., lowered) proximate to the tray and releases the disc. Upon placement of the disc into the recess formed about the recording tray, the engagement mechanism returns to the original position and the recording tray retracts into the recording device, wherein information may then be recorded onto the disc. The operation of transferring discs to the recording devices may be repeated until each recording device is utilized, a different operation is selected, the current operation is stopped, the entire task is complete, or otherwise.

Upon completion of recordation of data to the disc, the recording tray may extend and the disc engagement mechanism moves (e.g., lowers) such that it may once again engage the disc in the recording tray and raises the disc to allow retraction of the recording tray. The disc printing tray may then be initiated such that it moves into an extending position. The disc transport, if necessary, aligns the engagement mechanism and more specifically, the disc with the recess formed in the disc-printing tray. The engagement mechanism may then move (e.g., lower) the disc proximate to the print tray in a similar fashion as performed with the disc-recording device. The engagement mechanism releases (e.g., disengages) the disc within the recess of the print tray and returns to a position so as to enable the print tray to retract into the printing device.

The disc-printing tray may then move in general synchronization with the print heads of the print assembly to effectuate printing to the surface of the disc. During this process, because of the decoupling of the disc transport and the print assembly, the disc transport moves back to the supply receptacle to retrieve another disc and place the disc into the disc-recording device. It should be appreciated that this may be performed during printing to the disc.

Upon completion of the printing to the disc, and advantageously during recordation of data to the disc located in the recording device, the print assembly tray extends to its extended position. The disc transport then aligns itself with the disc located in the print tray, if necessary, and engages the completed disc. The disc is then transported to the storage receptacle or otherwise and subsequently placed in the storage receptacle, preferably in a similar fashion to that of the placement into the recess portion of the print tray and recording tray.

The disc transport then moves to one of the recording devices that has completed the recording process, removes the disc from the recording device tray, and places it into the print tray to be printed to. It should be appreciated that this cycle continues until the all of the selected tasks have been completed or the disc from the supply receptacle has been exhausted. It should further be appreciated that, if necessary, during the above operation, the supply receptacle may be removed for replacement as discussed herein. Likewise, the storage receptacle may be removed for removal of the completed cartridge and replace with an empty storage receptacle.

It is contemplated that the disc-publishing device is configured to provide status updates to the user for the tasks currently in operation. This may include providing the user with information such as, the number of discs that have been processed, the number of disc yet to be processed for the current task, the amount of ink left in the ink cartridges, or otherwise. It is further contemplated the disc-publishing device may provide error messages for reporting technical problems of the disc-publishing device such as empty ink cartridges, empty or full disc receptacles, or otherwise. This information is not only directed to the current tasks of the disc-publishing device, but may also include the overall operation of the disc-publishing device such as software updates, network connections, or otherwise and are communicated to the user through I/O devices such as the display or otherwise of the disc-publishing device.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. A portable integrated media apparatus comprising:
a disc transport movable along at least one axis, the disc transport including:
a disc engagement mechanism for selective engagement of at least one disc;
a print assembly for printing to the at least one disc, the print assembly including:
one or more print heads movable about a print axis; and
a movable print tray adapted to receive the at least one disc from the disc transport;
at least one recording device for recording to the at least one disc, the at least one recording device including:
a movable recording tray adapted to receive and record to the at least one disc from the disc transport;
at least one disc receptacle adapted to store the at least one disc;
a control unit for controlling the functions of the disc-publishing device;
a data interface for transmitting data; and
a data storage component for storing the data;
wherein the disc transport and the one or more prints heads are adapted to move independent of each other; and
wherein the control unit controls one or more functions of the disc-publishing device based on the data received from the data interface, stored in the data storage component, or both.

2. The apparatus of claim 1, further comprising a display panel for displaying input data, output data, or both.

3. The apparatus of claim 2, wherein the display panel is a liquid crystal display.

4. The apparatus of claim 1, wherein the control unit comprises a central processing unit and system memory for processing the data.

5. The apparatus of claim 4, further comprising a computer operating system that is configured for managing the use of system resources needed for controlling the one or more functions of the disc-publishing device.

6. The apparatus of claim 5, wherein the central processing unit and the system memory are generally located about a main circuit board, the main circuit board being configured for interconnecting the components of the disc-publishing device

7. The apparatus of claim 1, wherein the data interface is an input/output device, a data port, or an internet/networking port.

8. A portable integrated disc-publishing device comprising:
a disc transport movable along at least one axis, the disc transport including a disc engagement mechanism for selective engagement of at least one disc;
a print assembly for printing to the at least one disc, the print assembly including:
one or more print heads movable about a print axis; and
a movable print tray adapted to receive the at least one disc from the disc transport;
at least one recording device for recording to the at least one disc, the at least one recording device including:
a movable recording tray adapted to receive and record to the at least one disc from the disc transport;
at least one disc receptacle adapted to store the at least one disc;
a housing for providing support to one or more components of the disc-publishing device;
a data interface;
a computer operating system;
a control unit adapted to control one or more functions of the disc-publishing device, wherein the control unit includes:
a central processing unit; and
a system memory;
wherein the computer operating system is configured for managing the use of the system resources based on data received from the data interface.

9. The apparatus of claim 8, wherein computer operating system is stored on a data storage component.

10. The apparatus of claim 8, wherein the central processing unit and the system memory are generally located about a main circuit board, the main circuit board being configured for interconnecting the components of the disc-publishing device, the disc transport and the one or more prints heads are adapted to move independent of each other, or both.

11. The apparatus of claim 8, further comprising at least one of:
a video adapter coupled to an output port for a video display;
a input controller coupled to at least one of a keyboard port, a mouse port, a removable data storage, and the display panel;
a component interface, wherein the component interface is an IDE controller interface, a PCI bus interface, a SCSI interface, or AGP interface.
a data port, wherein the data port is a parallel port, a serial port, a USB port, or a firewire port;
a network port, wherein the network port is a modem port, a LAN port, a cable modem port, a DSL port, or a VDSL port; and
a wireless adapter.

12. The apparatus of claim 8, wherein the system memory is at least one of random-access memory and read-only memory.

13. The apparatus of claim 8, further comprising a display panel for displaying input data, output data, or both.

14. The apparatus of claim 8, wherein the data interface is an input/output device, a data port, or an internet/networking port.

15. A method for operating a portable integrated disc-publishing device comprising the steps of:
providing a portable disc-publishing device including:
a housing for providing support to one or more components of the disc-publishing device;
a disc transport movable along at least one axis, the disc transport including an engagement mechanism for selective engagement of at least one disc;
a print assembly for printing to the at least one disc, the print assembly including:
one or more print heads movable about a print axis;
at least one recording device for recording to the at least one disc;
at least one disc storage receptacle; and
a control unit for controlling one or more functions of the disc-publishing device, the control unit including;
a computer processing unit; and
a system memory;
wherein the disc transport and the one or more prints heads are adapted to move independent of each other;
receiving data from a data interface corresponding to a task;
transmitting the data from data interface to the control unit;
controlling the one or more functions of the disc-publishing device using the control unit to complete the task.

16. The method of claim 15, further comprising the step of providing a data storage component.

17. The method of claim 16, wherein the data storage component includes a computer operating system for managing the use of the system resources based on data received from the data interface.

18. The method of claim 17, further comprising the step of managing the use of system resources needed to control the one or more functions of the disc-publishing device.

19. The method of claim 15, further comprising the step of providing a display unit.

20. The method of claim 19, further comprising the step of displaying data input, output, or both based on the data received from the data interface, stored on a data storage component, or both.
